(19) United States
(12) Patent Application Publication
(10) Pub. No.: US 2016/0325496 A1
(43) Pub. Date: Nov. 10, 2016

(54) GENERATING THREE-DIMENSIONAL OBJECTS

(71) Applicant: HEWLETT-PACKARD DEVELOPMENT COMPANY, L.P., Houston, TX (US)

(72) Inventors: Alejandro Manuel De Pena, Sant Cugat del Valles (ES); Esteve Comas, Sant Quirze Del Valles (ES); Sergio Puigardeu, Barcelona (ES)

(21) Appl. No.: 15/110,947

(22) PCT Filed: Jan. 31, 2014
(86) PCT No.: PCT/US2014/014076

§ 371 Date: Jul. 12, 2016

(30) Foreign Application Priority Data
Jan. 16, 2014 (EP) PCT/EP2014/050841

(51) Int. Cl. B29C 67/00; B33Y 30/00; B33Y 50/02; B33Y 10/00

(52) U.S. Cl. CPC B29C 67/0081; B29C 67/0088; B29C 67/0092; B33Y 10/00; B33Y 30/00; B33Y 50/02; B29K 2105/251

(57) ABSTRACT

A three-dimensional object may be generated. A temperature sensor may be to measure a temperature distribution of build material delivered to a support member. A processor may be to mask a masking region of the measured temperature distribution or correct the measured temperature distribution, based on emissivity data of the build material. A heater may be to heat the build material to a target temperature distribution based on the corrected or masked measured temperature distribution. An energy source may be to apply energy to the build material to cause a portion of the build material to coalesce.

### BACKGROUND

Additive manufacturing systems that generate three-dimensional objects on a layer-by-layer basis have been proposed as a potentially convenient way to produce three-dimensional objects in small quantities.

The quality of objects produced by such systems may vary widely depending on the type of additive manufacturing technology used. Generally, low quality and low strength objects may be producible using lower cost systems, whereas high quality and high-strength objects may be producible using higher cost systems.

### BRIEF DESCRIPTION

Some examples are described with respect to the following figures:

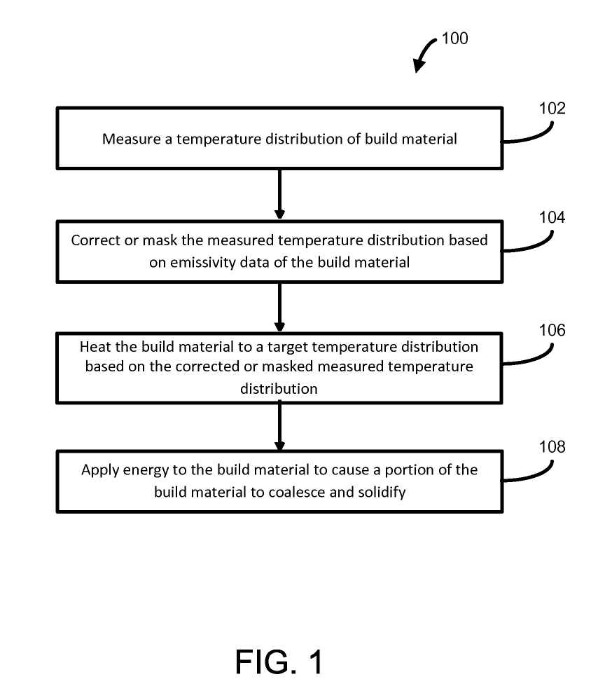

FIG. 1 is a flow diagram illustrating a method of generating a three-dimensional object according to some examples;

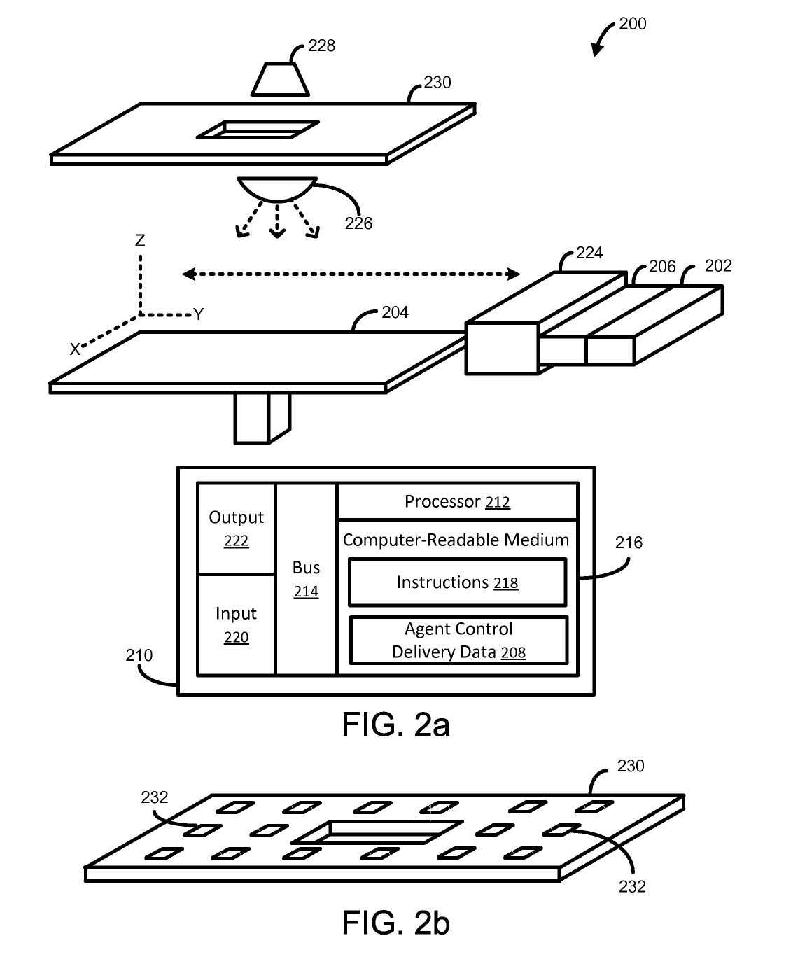

FIG. 2a is a simplified isometric illustration of an additive manufacturing system according to some examples;

FIG. 2b is a simplified isometric illustration of a heater for an additive manufacturing system according to some examples;

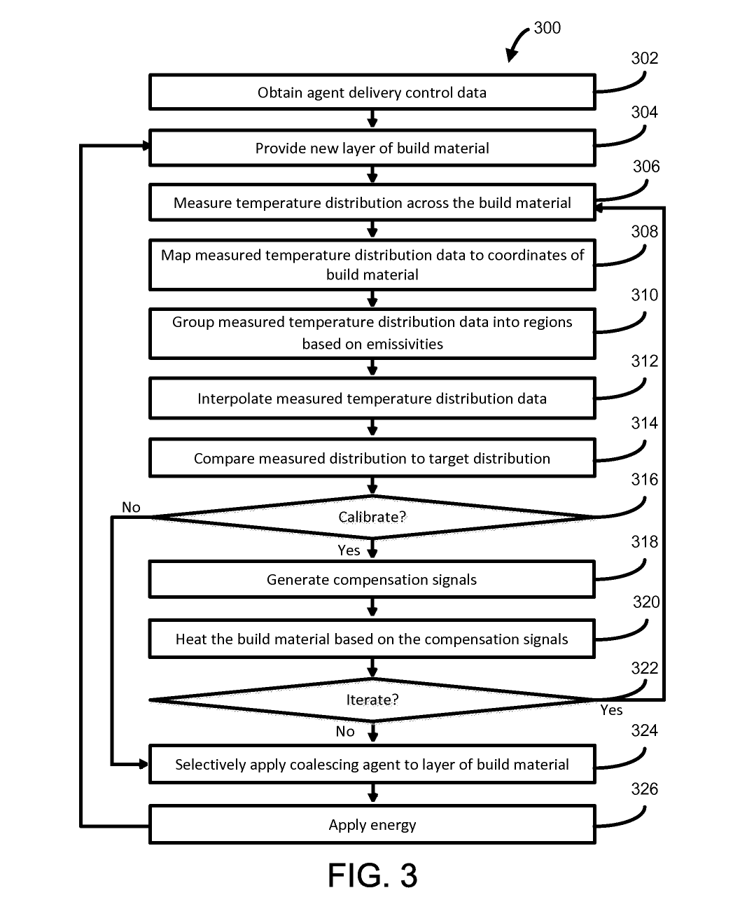

FIG. 3 is a flow diagram illustrating a method of three-dimensional object according to some examples;

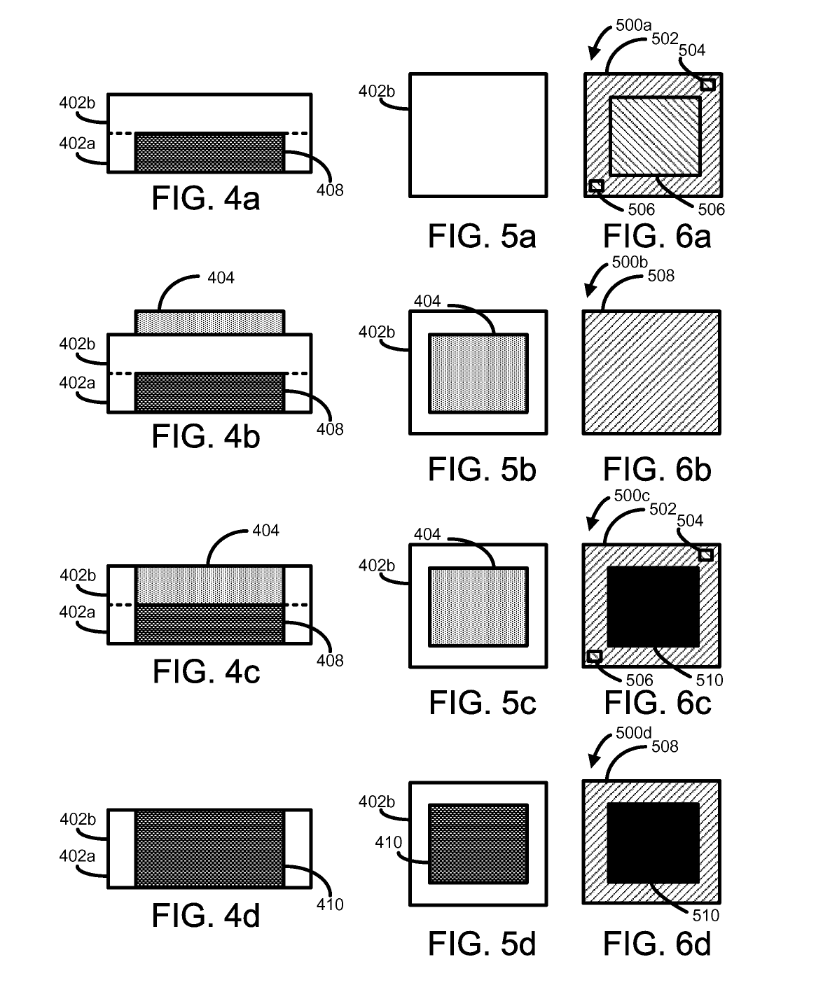

FIGS. 4a-d show a series of cross-sectional side views of layers of build material according to some examples;

FIGS. 5a-d show a series of top views of the layers of build material of FIGS. 4a-d according to some examples; and

FIGS. 6a-d show a series of schematic top views of temperature distributions according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Additive manufacturing techniques may generate a three-dimensional object through the solidification of portions of one or more successive layers of build material. The build material can be powder-based and the properties of generated objects are dependent on the type of build material and the type of solidification mechanism used.

Object properties may depend on the nature of the build materials used, the processes by which build material is solidified to form a desired three-dimensional object, and temperatures of build materials during such processes. Such properties may include, for example, surface roughness, accuracy, and strength.

A coalescing agent is a material that, when a suitable amount of energy is applied to a combination of build material and coalescing agent, may cause the build material to coalesce and solidify. However, in some examples, energy absorbed by build material on which coalescing agent has been delivered or has penetrated may also propagate into surrounding build material. The energy may be sufficient to cause surrounding build material to heat up. For example, the energy may propagate laterally through the build material, beneath the current layer, and/or into a future layer once it is applied on the newest layer. This effect may be exacerbated when using build materials that may have relatively low heat conductivity, as this may cause a heat reservoir to be formed beneath the surface of each newly created layer as it is formed. The heat in the reservoir may then slowly propagate laterally across the build material, below the newest layer, and/or into a future layer once it is applied on the newest layer.

Thus, the build material may be heated to a temperature suitable to cause softening and bonding of build material. This temperature could be above or below the material melting point. This may result in the subsequent solidification of portions of the build material that were not intended to be solidified and this effect is referred to herein as coalescence bleed. Coalescence bleed may result, for example, in a reduction in the overall accuracy of generated three-dimensional objects. For example, deformations may include three-dimensional portions such as a deformation extending laterally from the sides of the object, and a deformation extending below from the bottom of the object. Deformations may also include smaller irregularities in solidification due to undesired temperature distributions or heat conduction effects across the build material.

Moreover, spatial or temporal temperature gradients in the build material may decrease object accuracy through inhomogeneous contraction of the object because, for example, some build materials may be optimally processed in very narrow temperature windows.

Accordingly, the present disclosure allows temperature feedback of the build material to control operation of a heater that heats the build material. Thus, quality object properties and control of the generation of the three-dimensional object may be achieved, including reduction of deformations, control of mechanical properties, and consistency from build-to-build. In some examples, the heater may include an array of heating units that are designed and are spatially distributed to achieve desired heating of the build material. In some examples, a temperature sensor and controller may be designed in such a way to generate accurate temperature feedback, for example using algorithmic processing techniques, and/or by correcting for different emissivities across the build material resulting from varied properties of the build material. This may allow the build material to have a temperature distribution that better matches a predetermined target temperature distribution, for example a uniform or substantially uniform temperature distributions. Thus, greater object accuracy may be achieved, as it may be easier to maintain build material in an optimal temperature window. Moreover, a greater variety of materials may be used because materials having narrow temperature windows for optimal processing may still be useable.

FIG. 1 is a flow diagram illustrating a method of generating a three-dimensional object according to some examples. At block 102, a temperature distribution of build material delivered to a support member may be measured. At block 104, based on emissivity data of the build material, the measured temperature distribution may be corrected or a masking region of the measured temperature distribution may be masked. At block 106, the build material may be heated to a target temperature distribution based on the corrected or masked measured temperature distribution. At block 108, energy may be applied to the build material to cause a portion of the build material to coalesce and solidify.

FIG. 2a is a simplified isometric illustration of an additive manufacturing system 200 according to some examples. The system 200 may be operated, as described further below with reference to the flow diagram of FIG. 3, to generate a three-dimensional object.

In some examples the build material may be a powder-based build material. As used herein the term powder-based materials is intended to encompass both dry and wet powder-based materials, particulate materials, and granular materials. In some examples, the build material may include a mixture of air and solid polymer particles, for example at a ratio of about 40% air and about 60% solid polymer particles. One suitable material may be Nylon 12, which is available, for example, from Sigma-Aldrich Co. LLC. Another suitable Nylon 12 material may be PA 2200 which is available from Electro Optical Systems EOS GmbH. Other examples of suitable build materials may include, for example, powdered metal materials, powdered composited materials, powder ceramic materials, powdered glass materials, powdered resin material, powdered polymer materials, and the like, and combinations thereof. It should be understood, however, that the examples described herein are not limited to powder-based materials or to any of the materials listed above. In other examples the build material may be a paste or a gel. According to one example a suitable build material may be a powdered semi-crystalline thermoplastic material. Some materials may have a low heat conductivity, resulting in increased risk of coalescence bleed. For example some nylons may have a heat conductivity of about 0.1 W/m K at room temperature and about 0.2 W/m K at its melting point.

The additive manufacturing system 200 may include a system controller 210. Any of the operations and methods disclosed herein may be implemented and controlled in the additive manufacturing system 200 and/or controller 210.

The controller 210 may include a processor 212 for executing instructions such as those described in the methods herein. The processor 212 may, for example, be a microprocessor, a microcontroller, a programmable gate array, an application specific integrated circuit (ASIC), a computer processor, or the like. The processor 212 may, for example, include multiple cores on a chip, multiple cores across multiple chips, multiple cores across multiple devices, or combinations thereof. In some examples, the processor 212 may include at least one integrated circuit (IC), other control logic, other electronic circuits, or combinations thereof.

The controller 210 may support direct user interaction. For example, the additive manufacturing system 200 may include user input devices 220 coupled to the processor 212, such as one or more of a keyboard, touchpad, buttons, keypad, dials, mouse, track-ball, card reader, or other input devices. Additionally, the additive manufacturing system 200 may include output devices 222 coupled to the processor 212, such as one or more of a liquid crystal display (LCD), printer, video monitor, touch screen display, a light-emitting diode (LED), or other output devices. The output devices 222 may be responsive to instructions to display textual information or graphical data.

The processor 212 may be in communication with a computer-readable storage medium 216 via a communication bus 214. The computer-readable storage medium 216 may include a single medium or multiple media. For example, the computer readable storage medium 216 may include one or both of a memory of the ASIC, and a separate memory in the controller 210. The computer readable storage medium 216 may be any electronic, magnetic, optical, or other physical storage device. For example, the computer-readable storage medium 216 may be, for example, random access memory (RAM), static memory, read only memory, an electrically erasable programmable read-only memory (EEPROM), a hard drive, an optical drive, a storage drive, a CD, a DVD, and the like. The computer-readable storage medium 216 may be non-transitory. The computer-readable storage medium 216 may store, encode, or carry computer executable instructions 218 that, when executed by the processor 212, may cause the processor 212 to perform any one or more of the methods or operations disclosed herein according to various examples.

The system 200 may include a coalescing agent distributor 202 to selectively deliver coalescing agent to successive layers of build material provided on a support member 204. According to one non-limiting example, a suitable coalescing agent may be an ink-type formulation comprising carbon black, such as, for example, the ink formulation commercially known as CM997A available from Hewlett-Packard Company. In one example such an ink may additionally comprise an infra-red light absorber. In one example such an ink may additionally comprise a near infra-red light absorber. In one example such an ink may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from Hewlett-Packard Company.

In one example the support member 204 has dimensions in the range of from about 10 cm by 10 cm up to 100 cm by 100 cm. In other examples the support member 204 may have larger or smaller dimensions. The support member 204 may be a fixed part of the system 200, or may not be a fixed part of the system 200, instead being, for example, a part of a removable module.

The controller 210 controls the selective delivery of coalescing agent to a layer of provided build material in accordance with instructions comprising agent delivery control data 208.

The agent distributor 202 may be a printhead, such as thermal printhead or piezo inkjet printhead. The printhead may have arrays of nozzles. In one example, printheads such as those commonly used in commercially available inkjet printers may be used. In other examples, the agents may be delivered through spray nozzles rather than through printheads. Other delivery mechanisms may be used as well.

The agent distributor 202 may be used to selectively deliver, e.g. deposit, coalescing agent when in the form of a suitable fluid such as liquid. In some examples, the agent distributor 202 may be selected to deliver drops of agent at a resolution of between 300 to 1200 dots per inch (DPI), for example 600 DPI. In other examples the agent distributor 202 may be selected to be able to deliver drops of agent at a higher or lower resolution. In some examples, the agent distributor 202 may have an array of nozzles through which the agent distributor 202 is able to selectively eject drops of fluid. In some examples, each drop may be in the order of about 10 pico liters (pl) per drop, although in other examples the agent distributor 202 is able to deliver a higher or lower drop size. In some examples the agent distributor 202 is able to deliver variable size drops.

In some examples the coalescing agent may comprise a liquid carrier, such as water or any other suitable solvent or dispersant, to enable it to be delivered via a printhead.

In some examples the printheads may be drop-on-demand printhead. In other examples the printhead may be continuous drop printhead.

In some examples, the agent distributor 202 may be an integral part of the system 200. In some examples, the agent distributor 202 may be user replaceable, in which case they may be removably insertable into a suitable agent distributor receiver or interface module of the system 200.

In the example illustrated in FIG. 2a, the agent distributor 202 may have a length that enables it to span the whole width of the support member 204 in a so-called page-wide array configuration. In one example this may be achieved through a suitable arrangement of multiple printheads. In other examples a single printhead having an array of nozzles having a length to enable them to span the width of the support member 204 may be used. In other examples, the agent distributor 202 may have a shorter length that does not enable it to span the whole width of the support member 204.

The agent distributor 202 may be mounted on a moveable carriage to enable it to move bi-directionally across the length of the support 204 along the illustrated y-axis. This enables selective delivery of coalescing agent across the whole width and length of the support 204 in a single pass. In other examples the agent distributor 202 may be fixed, and the support member 204 may move relative to the agent distributor 202.

It should be noted that the term ‘width’ used herein is used to generally denote the shortest dimension in the plane parallel to the x and y axes illustrated in FIG. 2a, whilst the term ‘length’ used herein is used to generally denote the longest dimension in this plane. However, it will be understood that in other examples the term ‘width’ may be interchangeable with the term ‘length’. For example, in other examples the agent distributor 202 may have a length that enables them to span the whole length of the support member 204 whilst the moveable carriage may move bi-directionally across the width of the support member 204.

In another example the agent distributor 202 does not have a length that enables it to span the whole width of the support member but are additionally movable bi-directionally across the width of the support member 204 in the illustrated x-axis. This configuration enables selective delivery of coalescing agent across the whole width and length of the support 204 using multiple passes. Other configurations, however, such as a page-wide array configuration, may enable three-dimensional objects to be created faster.

The coalescing agent distributor 202 may include a supply of coalescing agent or may be connectable to a separate supply of coalescing agent.

The system 200 further comprises a build material distributor 224 to provide, e.g. deliver and/or deposit, successive layers of build material on the support 204. Suitable build material distributors 224 may include, for example, a wiper blade and a roller. Build material may be supplied to the build material distributor 224 from a hopper or build material store. In the example shown the build material distributor 224 moves across the length (y-axis) of the support 204 to deposit a layer of build material. As previously described, a layer of build material will be deposited on the support 204, whereas subsequent layers of build material will be deposited on a previously deposited layer of build material. The build material distributor 224 may be a fixed part of the system 200, or may not be a fixed part of the system 200, instead being, for example, a part of a removable module.

In some examples, there may be additional coalescing agent distributors, such as the agent distributor 206. In some examples, the distributors of system 200 may be located on the same carriage, either adjacent to each other or separated by a short distance. In other examples, two or more carriages each may contain one or more distributors. For example, each distributor may be located in its own separate carriage. Any additional distributors may have similar features as those discussed earlier with reference to the coalescing agent distributor 202. However, in some examples, different agent distributors may deliver different coalescing agents, for example.

In the example shown the support 204 is moveable in the z-axis such that as new layers of build material are deposited a predetermined gap is maintained between the surface of the most recently deposited layer of build material and lower surface of the agent distributor 202. In other examples, however, the support 204 may not be movable in the z-axis and the agent distributor 202 may be movable in the z-axis.

The system 200 may additionally include an energy source 226 to apply energy to build material to cause the solidification of portions of the build material according to where coalescing agent has been delivered or has penetrated. In some examples, the energy source 226 is an infra-red (IR) radiation source, near infra-red radiation source, halogen radiation source, or a light emitting diode. In some examples, the energy source 226 may be a single energy source that is able to uniformly apply energy to build material deposited on the support 204. In some examples, the energy source 226 may comprise an array of energy sources.

In some examples, the energy source 226 is configured to apply energy in a substantially uniform manner to the whole surface of a layer of build material. In these examples the energy source 226 may be said to be an unfocused energy source. In these examples, a whole layer may have energy applied thereto simultaneously, which may help increase the speed at which a three-dimensional object may be generated.

In other examples, the energy source 226 is configured to apply energy in a substantially uniform manner to a portion of the whole surface of a layer of build material. For example, the energy source 226 may be configured to apply energy to a strip of the whole surface of a layer of build material. In these examples the energy source may be moved or scanned across the layer of build material such that a substantially equal amount of energy is ultimately applied across the whole surface of a layer of build material.

In some examples, the energy source 226 may be mounted on the moveable carriage.

In other examples, the energy source 226 may apply a variable amount of energy as it is moved across the layer of build material, for example in accordance with agent delivery control data 208. For example, the controller 210 may control the energy source only to apply energy to portions of build material on which coalescing agent has been applied.

In further examples, the energy source 226 may be a focused energy source, such as a laser beam. In this example the laser beam may be controlled to scan across the whole or a portion of a layer of build material. In these examples the laser beam may be controlled to scan across a layer of build material in accordance with agent delivery control data. For example, the laser beam may be controlled to apply energy to those portions of a layer of on which coalescing agent is delivered.

The system 200 may additionally include a heater 230 to emit heat to maintain build material deposited on the support 204 within a predetermined temperature range. The heater 230 may have any suitable configuration. One example is shown in FIG. 2b, which is a simplified isometric illustration of a heater 230 for an additive manufacturing system according to some examples. The heater 230 may have an array of heating elements 232, as shown. The heating units 232 may be each be any suitable heating unit, for example a heat lamp such as an infra-red lamp. The heating units 232 may have a suitable shapes or configurations such as rectangular as shown in FIG. 2b. In other examples they may be circular, rod shaped, or bulb shaped, for example. The configuration may be optimized to provide a homogeneous heat distribution toward the area spanned by the build material. Each heating unit 232, or groups of heating units 232, may have an adjustable current or voltage supply to variably control the local energy density applied to the build material surface.

Each heating units 232 may correspond to its own respective area of the build material, such that each heating unit 232 may emit heat substantially toward its own area rather than areas covered by other heating units 232. For example, each of the sixteen heating units 232 in FIG. 2b may heat one of sixteen different areas of the build material, where the sixteen areas collectively cover the entire area of the build material. However, in some examples, each heating unit 232 may also emit, to a lesser extent, some heat which influences an adjacent area.

The system 200 may additionally include a temperature sensor 228, for example a point contactless temperature sensor such as a one or more thermocouples or one or more thermopile, or such as a thermographic camera. The temperature sensor 228 may be to capture temperature values or an image representing a radiation distribution emitted by each point of the build material across the area spanned by the build material on the support member 204. The temperature sensor 228 may output the radiation distribution to the controller 210, which may determine a temperature distribution across the build material based on known relationships, such as a blackbody distribution, between temperature and radiation intensity for the material used as the build material. For example, the radiation frequencies of the radiation distribution may have their highest intensities at particular values in the infra-red (IR) range. This may be used to determine the temperature distribution comprising a plurality of temperatures across the build material.

The thermographic camera 228 may be oriented generally centrally and facing generally directly toward the build material, such that the optical axis of the camera targets the center line of the support member 204, to allow a generally symmetric capture of radiation from the build material. This may minimize perspective distortions of the build material surface, thus minimizing the need for corrections, and reducing errors in measured temperature values versus real temperature values. Additionally, the thermographic camera 228 may be able to (1) capture the image over a wide region covering an entire layer of build material, for example by using suitable magnification, (2) capture a series of images of the entire layer which are later averaged, or (3) capture a series of images each covering a portion of the layer that taken together cover the entire layer. In some examples, the thermographic camera 228 may be in a fixed location relative to the support member 204, but in other examples may be moveable if other components, when moving, disrupt the line of sight between the camera 228 and the support member 204.

Although FIG. 2a illustrates the temperature sensor 228 as a thermographic camera, in other examples the temperature sensor 228 may include an array of fixed-location pyrometers which each capture radiation from a single area, each area corresponding to the area generally heated by one of the heating units 232 of the heater 230. In other examples, the temperature sensor 228 may be a single pyrometer which may be operable to sweep or scan over the entire area of the build material.

Although in FIG. 2a the energy source 226, heater 230, and thermographic camera 228 are shown in particular locations above the support member 204, they may each be placed in any suitable location above or around the support member 214.

FIG. 3 is a flow diagram illustrating a method 300 of generating a three-dimensional object according to some examples. The method may be computer implemented. In some examples, the orderings shown may be varied, such that some steps may occur simultaneously, some steps may be added, and some steps may be omitted.

In describing FIG. 3, reference will be made to FIGS. 2, 4a-d, 5a-d, and 6a-d. FIGS. 4a-d show a series of cross-sectional side views of layers of build material according to some examples. FIGS. 5a-d show a series of top views of the layers of build material of FIGS. 4a-d according to some examples. FIGS. 6a-d show a series of schematic top views of temperature distributions according to some examples. The method 300 may allow heating based on temperature feedback during processing of each layer, every group of layers such as every second or third layer, or as a single initial calibration step.

Turning to 302, the controller 210 may obtain agent delivery control data 208. The agent delivery control data 208 may define for each slice of the three-dimensional object to be generated the portions or the locations on the build material, if any, at which coalescing agent is to be delivered.

The agent delivery control data 208 may be derived, for example, by a suitable three-dimensional object processing system. In some examples the three-dimensional object processing system may be comprised within the additive manufacturing system 200. For example, the instructions 218 may additionally include instructions that, when executed by the processor 212, cause the processor 212 to operate as a three-dimensional object processing system as described herein. In other examples the three-dimensional object processing system may be external to the additive manufacturing system 400. For example, the three-dimensional object processing system may be a software application, or part of a software application, executable on a computing device separate from the system 200.

In some examples, the agent delivery control data 208 may be generated based on object design data representing a three-dimensional model of an object to be generated, and/or from object design data representing properties of the object. The model may define the solid portions of the object, and may be processed by the three-dimensional object processing system to generate slices of parallel planes of the model. Each slice may define a portion of a respective layer of build material that is to be solidified by the additive manufacturing system. The object property data may define properties of the object such as density, surface roughness, strength, and the like.

The object design data and object property data may be received, for example, from a user via an input device 220, as input from a user, from a software driver, from a software application such as a computer aided design (CAD) application, or may be obtained from a memory storing default or user-defined object design data and object property data.

In some examples the object processing system may obtain data relating to characteristics of the additive manufacturing system 200. Such characteristics may include, for example, build material layer thickness, properties of the coalescing agent, properties of the build material, and properties of the energy source 226, properties of the heater 230, and properties of the temperature sensor 228.

The agent delivery control data 208 may describe, for each layer of build material to be processed, locations or portions on the build material at which coalescing agent is to be delivered. In one example the locations or portions of the build material at which coalescing agent is to be delivered are defined by way of respective patterns.

Depending on the characteristics described above, the density at which coalescing agent is to be delivered may be varied. For example, when a portion of build material on which coalescing agent has been delivered or has penetrated receives applied energy, the energy absorbed by those portions propagates to other surrounding areas. In one example, the properties of the coalescing agent and the amount of coalescing agent delivered may be chosen such that energy propagates in a sphere in the range of about 1.5 times the layer thickness. This may help ensure not only sufficient inter-layer bonding, but also sufficient bonding between laterally adjacent portions of build material. The density may also be varied to regulate temperature of the build material, as will be discussed in reference to block 310.

In this way, the object processing system may, for example, determine that the lateral spacing between adjacent drops of coalescing agent may be increased whilst still ensuring sufficient object strength. Doing so reduces the average density at which coalescing agent may be delivered to a layer of build material, and hence reduces consumption of coalescing agent, but without affecting the object strength.

At 304, a layer 402b of build material may be provided, as shown in FIGS. 4a and 5a. For example, the controller 210 may control the build material distributor 224 to provide the layer 402b on a previously completed layer 402a on the support member 204 by causing the build material distributor 224 to move along the y-axis as discussed earlier. The completed layer 402a may include a solidified portion 408. Although a completed layer 402a is shown in FIGS. 4a-d for illustrative purposes, it is understood that the steps 304 to 326 may initially be applied to generate the first layer 402a.

In some examples, the thickness of the layer 402b of build material provided may have a value selected from the range of between about 50 to about 300 microns, or about 90 to about 110 microns, or about 250 microns, although in other examples thinner or thicker layers of build material may be provided. The thickness may be controlled by the controller 210, for example based on the agent delivery control data 208.

At 306, a temperature distribution of the build material may be determined. For example, the temperature sensor such as the thermographic camera 228 may obtain temperature feedback, for example by capturing an image representing a radiation distribution of the build material. As discussed earlier, in other examples, a series of images may be taken to generate a composite or averaged image representing the radiation distribution. The radiation distribution may be used by the controller 210 or by a processor in the camera to determine a temperature distribution of the build material based on known relationships, such as a blackbody distribution, between temperature and radiation intensity for the material used as the build material. The known relationship may, for example, assume a fixed conversion from radiant intensity to temperature. This approximation may be corrected at block 310, as will be discussed.

At block 308, a coordinate transformation algorithm may be used to map the coordinates of the measured temperature distribution to the spatial coordinates of the layer 402b of the material. The known relationship between these coordinates may be stored in a memory of the controller 210. If the sensor 228 and support member 204 are movable relative to each other, then a plurality of relationships may be stored for each possible relative spatial configuration of the sensor 228 and the support member 204. The coordinate transformation algorithm may correct for perspective error and may include a scale factor conversion between pixel distances of the measured distribution and real world lengths along the build material. In some examples, additional fine adjustment of the mapping may involve calibrating based on patterns provided in the build material which are detectable by the sensor 228. For example, the build area may be provided in locations, for example the corners of the build area, with patterns such as dot grids or interference patterns, and/or with delivery of a different-colored build materials, to allow for detection by the camera to allow subsequent mapping between the measured temperature distribution and the layer 402b.

At block 310, the temperature distribution data may be subdivided and grouped into regions having constant or generally constant emissivities based on the agent control delivery data 208 using the controller 210. The emissivity of a material is the relative ability of its surface to emit energy. The emissivity may range be any percentage up to 100%. An emissivity of 50% corresponds to a material having a given temperature and emitting half the amount of energy emitted by an ideal blackbody at that same temperature. Emissivity may, for example, depend on the type of material, the material's chemical composition, surface characteristics such as degree of roughness, material geometry such as thickness of the material layer, and other factors.

As discussed earlier, the agent control delivery data 208 may define areas where agents are delivered and the locations of the build material in which agents are to be delivered and/or solidification is desired. Thus, groupings of emissivity regions in the temperature distribution data may be determined based on these agent control delivery data 208, and based on known properties of the materials used, and properties of such solidified, non-solidified, heated, melted, and non-melted regions of these materials, and resultant surface characteristics of these materials, geometries of the delivered layers, and the like. All of the above data may be considered emissivity data. Thus, for example, in FIG. 4a, the central solidified region 408 of layer 402a may be expected to cause the center of the surface of layer 402b to have a different emissivity than the outer surface regions of layer 402b, for example (1) due to heat conduction from the completed layer 402a below, and (2) due to the optical depth of the build material being greater than the thickness of each layer of build material, meaning that the solidified region 408 of layer 402a may be visible to the temperature sensor 228 thereby affecting emissivity. In some examples, as discussed earlier, delivery of the agent 404 may be performed prior to block 306. In such case, the agent 404 in the layer 402b itself may be expected to additionally affect emissivity in the central region of the layer 402b. In general, the layers of build material may each be given a weight when determining emissivity of the surface of the top layer. For example, more weight may be given to a layer the closer the layer is to the current top layer.

In other examples, such as if the heating based on feedback of blocks 306 to 322 may be performed prior to delivering the first layer of build material, as will be discussed, then emissivity of the support member 204 or a calibration tile on the support member 204 may be determined.

Thus, one or more groupings of generally constant emissivity may be generated, wherein in the example of FIG. 4a, two groupings may be generated based on the emissivity data.

In some examples, based on the groupings, the temperature distribution data, which may initially at block 306 have been generated based on an assumption of a fixed conversion from radiant intensity to temperature, may be corrected based on the groupings and emissivity data.

In other examples, one or more groupings may be selected for use as feedback, and the one or more other groupings may be not be used as feedback, e.g. they may be masked. In some examples, the sensor 228 may be programmed to deliver images only in predetermined groupings expected or desired to have constant emissivity. For example, the predeterminations may be made based on the agent delivery control data 208 defining regions in which it is expected that coalescing agent is not to be delivered.

At block 312, the data pixels of the temperature distribution data may be interpolated to increase the resolution of the temperature distribution data such that it has more data pixels. Interpolation is a method of determining new data points between a set of known data points. For example, an interpolation algorithm may be applied by the controller 210 to triangulate the planar set of data pixels having X and Y coordinates to determine a regular grid of interpolated data pixels representing interpolated temperature values in the temperature distribution. The interpolation algorithm may use linear or smooth polynomial interpolation, for example. In some examples, such as if the temperature sensor 228 did not sufficiently capture an image of the outer areas of build material, then grid points outside of the triangulation area may be extrapolated.

At this stage, the temperature distribution may appear as the temperature distribution 500a of FIG. 6a or 500c of FIG. 6c, depending on whether the groupings were determined, respectively, for corrective action or for masking, as discussed earlier above with reference to block 310. FIG. 6a shows the region 502 may have the baseline temperature, and regions 506 may have respective temperatures greater than the baseline temperature. These non-uniformities may result from the coalescence and solidification of portions of the previously deposited layer, for example during energy application at block 312. The area where coalescing agent 404 had been delivered during the creation of the previous layer 402a may have a substantially greater than baseline temperature, as shown in FIG. 6a. Additionally, a region 504 may have a temperature lower than the baseline temperature of region 502. FIG. 6c is similar to FIG. 6a except that region 506 is a masking region 510.

At block 314, the temperature distribution 500a or 500c may be compared by the controller 210, respectively, with a predetermined target temperature distribution 500b of FIG. 6b or 500d of FIG. 6d stored in a memory of the controller 210. FIG. 6b corresponds to an unmasked distribution, and FIG. 6d corresponds to a masked distribution, where the latter is given the same mask as the measured masked temperature distribution 500c. FIG. 6d is similar to FIG. 6b except that it includes a masking region 510.

Each target temperature distribution 500b and 500d may have a uniform or substantially uniform temperature region 508. In other examples, the target temperature distribution may instead be a custom non-uniform temperature distribution. In general, the target temperature distribution is selected such that targeting it may allow sufficient temperature regulation to achieve desired object properties and suitable reduction of deformations.

In some examples, the comparison of the distributions may involve determining a difference between each corresponding pixel of the temperature distribution 500a and the target temperature distribution 500b, or in examples involving masking, of the temperature distribution 500c and the target temperature distribution 500d.

At decision block 316, if the temperature distribution 500a or 500c is substantially similar to its target temperature distribution 500b or 500d or deviates from the target temperature distribution by less than a predetermined degree, then the method 300 may proceed to block 324. If the temperature distribution 500a or 500c is not substantially similar to its target temperature distribution 500b or 500d or deviates from the target temperature distribution by greater than a predetermined degree, then the method 300 may proceed to block 324.

At block 318, based on the differences between the temperature distribution 500a and the target temperature distribution 500b or 500d, a temperature compensation signal may be generated for each of the heating units 232. Each compensation signal may represent, for example, a voltage or current to be supplied to a respective heating unit 232. Each heating unit 232 may correspond to a region of pixels comprising a grid of pixels in the temperature distribution 500a that likewise corresponds to a spatial region on the surface of the build material.

In some examples, generating the compensation signal may be performed by averaging the difference between pixels in the corresponding regions of the measured temperature distribution 500a and the target temperature distribution.

In some examples, generating the compensation signal may be performed based on a thermal process model which mathematically models heat diffusion based on the agent delivery control data 208. The model may involve solving the heat equation using finite element analysis, or may involve any other suitable method.

In some examples, generating the compensation signal may involve the following process. A physical model for radiation delivery from the heater 230 to the build material may be defined. The physical model may be represented mathematically as an objective function. The physical model may, for example, be a ray tracing model, which may, for example, incorporate known input parameters including physical factors such as the geometry of the heater 230 and the support member 414 and build material, and any other physical factors affecting radiation trajectory. The ray tracing model may also incorporate unknown input parameters including compensation signals, which e.g. defining voltage or current to be supplied to each of the heating units 232. Based on the known and unknown input parameters, the ray tracing model may output a model temperature distribution over the build material.

The unknown input parameters, e.g. the compensation signals such as voltages or currents, may be determined by applying a minimization algorithm to the objective function to minimize the difference between the model temperature distribution and the known target temperature distribution. Any suitable minimization algorithm may be used, for example least square fitting such as by using a Levenberg Marquardt algorithm. Thus, the determined compensation signals may be used to heat the build material to the target temperature distribution.

In some examples, a neural network model may instead be used to determine the unknown input parameters, e.g. the compensation signals such as voltages or currents, based on the known parameters. The neural network model may, in some examples, be self-adapting to the specific features of the system 200 including the heater 230 and the support member 204.

In some examples, generating the compensation signal may be performed based on stored look-up tables defining heat diffusion characteristics of various three-dimensional objects. Thus, the controller 210 may match the agent delivery control data 208 with a suitable look-up table to adjust the compensation signal. The look up tables may have been pre-calculated using any of the models above, such as the physical model, the neural network model, or thermal process model, for example.

In some examples, any combination of the above methods in determining the compensation signals may be used.

At 320, the build material may be heated by the heater 230 to heat the build material to the target temperature distribution 500b or 500d which is shown in FIG. 6b as having a single region 508 of uniform temperature distribution. In examples involving masking, the heating units 232 covering the build material region corresponding to the masking region 510 may not be used for heating. Although it is shown that the target temperature distribution 500b or 500d is reached for illustrative purposes, in some examples a number of iterations of blocks 306 to 322 may be performed until the target temperature distribution 500b or 500d is sufficiently reached. Each of the heating units 232 may heat, based on their respective compensation signals, their respective spatial regions of the build material to achieve the target temperature distribution 500b or 500d.

In some examples, use of the heater 230 may help reduce the amount of energy that has to be applied by the energy source 226 at block 326 to cause coalescence and subsequent solidification of build material on which coalescing agent has been delivered or has penetrated. However, the temperatures of the target temperature distribution 500b or 500d may be set below a temperature at which the build material would experience bonding in the presence of coalescing agent 404. For example, the target temperatures may range between about 155 and about 160 degrees Celsius, or be centered at about 160 degrees Celsius depending on the properties of the build material used. Pre-heating may help reduce the amount of energy that has to be applied by the energy source 226 to cause coalescence and subsequent solidification of build material on which coalescing agent has been delivered or has penetrated.

However, in other examples, pre-heating may not be desired. However, in this example, the target temperature distribution may likewise be lower than a temperature at which the build material would experience bonding in the presence of coalescing agent 404.

At decision block 322, it may be determined whether an additional iteration of heating based on temperature feedback may be performed to bring the temperature distribution closer to the target temperature distribution. This determination may be based on the difference between the temperature distribution 500a or 500c and the target temperature distribution 500b or 500d determined in the current iteration at block 314. If the difference was below a threshold, then it may be presumed the heater 230 has achieved the target distribution 500b or 500d to a sufficient degree, and the method 300 may proceed to block 324. Otherwise, the method may proceed to block 308.

At 324, a coalescing agent 404 may be selectively delivered to one or more portions of the surface of the layer 402b of build material, as shown in FIGS. 4b and 5b. As discussed earlier, the agent 404 may be delivered by agent distributor 202, for example in the form of fluids such as liquid droplets.

The selective delivery of the agent 404 may be performed in patterns on portions of the layer 402b that the agent delivery control data 208 may define to become solid to form part of the three-dimensional object being generated. “Selective delivery” means that coalescing agent may be delivered to selected portions of the surface layer of the build material in various patterns. The patterns may be defined by the agent delivery control data 208.

FIGS. 4c and 5c shows coalescing agent 404 having penetrated substantially completely into the layer 402b of build material, but in other examples, the degree of penetration may be less than 100%. The degree of penetration may depend, for example, on the quantity of agent delivered, on the nature of the build material, on the nature of the agent, etc. FIG. 6c shows that the build material may still have a substantially uniform temperature distribution 500c having the uniform region 508.

At 326, a predetermined level of energy may be temporarily applied to the layer 402b of build material. In various examples, the energy applied may be infra-red or near infra-red energy, microwave energy, ultra-violet (UV) light, halogen light, ultra-sonic energy, or the like. The length of time the energy is applied for, or energy exposure time, may be dependent, for example, on one or more of: characteristics of the energy source; characteristics of the build material; and characteristics of the coalescing agent. The type of energy source used may depend on one or more of: characteristics of the build material; and characteristics of the coalescing agent. In one example, the energy may be applied for a predetermined length of time.

The temporary application of energy may cause portions of the build material on which coalescing agent 404 has been delivered or has penetrated to heat up above the melting point of the build material and to coalesce. For example, the temperature of the layer 402b may achieve about 220 degrees Celsius. Upon cooling, the portions which have coalesced become solid and form part of the three-dimensional object being generated. As discussed earlier, one such portion 408 may have been generated in a previous iteration. The heat absorbed during the application of energy may propagate to the previously solidified portion 408 to cause part of portion 408 to heat up above its melting point. This effect helps creates a portion 410 that has strong interlayer bonding between adjacent layers of solidified build material, as shown in FIG. 4d.

In some examples, the application of energy may cause new temperature non-uniformities to appear, for example similar but not necessarily the same as the non-uniformities in FIG. 6a. Thus, during treatment of the subsequent layer, newly non-uniform temperature distribution may be transitioned to a target temperature distribution.

The combination of the energy supplied, the build material, and the coalescing agent 404 may be selected such that, excluding the effects of any coalescence bleed: i) portions of the build material on which no coalescing agent 404 have been delivered do not coalesce when energy is temporarily applied thereto; and ii) portions of the build material on which only coalescing agent 404 has been delivered or has penetrated coalesce when energy is temporarily applied thereto do coalesce.

After a layer of build material has been processed as described above, new layers of build material may be provided on top of the previously processed layer of build material. In this way, the previously processed layer of build material acts as a support for a subsequent layer of build material. The process of blocks 304 to 326 may then be repeated to generate a three-dimensional object layer by layer.

As mentioned earlier, the method 300 may allow heating based on temperature feedback for each layer, or for every group of layers such as every second or third layer. For example, the method 300 as described in detail above describes heating based on temperature feedback during block 306 to 322 after delivering build material at block 304. In other examples, block 324, which involves delivering agents, may be performed between blocks 304 and 306, such that block 316 proceeds to block 326 if calibration is not to be done. In such examples, both delivery of build material and agents is performed prior to the heating based on temperature feedback of blocks 306 to 322. However, this example still allows for heating based on feedback for each layer or group of layers.

However, in other examples, the heating based on feedback may be performed as a single calibration step initially. For example, the method 300 may proceed as shown, except that the blocks 306 to 322 may be performed only for a first layer which has yet to be provided with any agents. In other examples, block 304 may occur after block 322, such that block 316 proceeds to block 304 if calibration is not to be done. In such case, the heating based on feedback of blocks 306 to 322 may be performed prior to delivering the first layer of build material. In yet other examples, the heating based on feedback of blocks 306 to 322 may be performed when quality metrics such as measured deformations exceed a threshold, or if a user activates the feedback system.

All of the features disclosed in this specification (including any accompanying claims, abstract and drawings), and/or all of the steps of any method or process so disclosed, may be combined in any combination, except combinations where at least some of such features and/or steps are mutually exclusive.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

1. An apparatus for generating a three-dimensional object, the apparatus comprising:
a temperature sensor to measure a temperature distribution of build material delivered to a support member;
a processor to, based on emissivity data of the build material, mask a masking region of the measured temperature distribution or correct the measured temperature distribution;
a heater to heat the build material to a target temperature distribution based on the corrected or masked measured temperature distribution; and
an energy source to apply energy to the build material to cause a portion of the build material to coalesce and solidify.

2. The apparatus of claim 1 further comprising an agent distributor to selectively delivering coalescing agent to the portion of the build material to cause the portion to coalesce when the energy is applied.

3. The apparatus of claim 1 wherein the heater comprises an array of heating units to heat the build material to the target temperature distribution based on the corrected or masked measured temperature distribution.

4. The apparatus of claim 1 wherein the measured temperature distribution is corrected based on the emissivity data.

5. The apparatus of claim 4 wherein the processor is to correct the measured temperature distribution by:
grouping the measured temperature distribution into regions of generally constant emissivity; and
correcting a temperature of at least one of the regions based on its emissivity.

6. The apparatus of claim 1 wherein the masking region is masked based on the emissivity data.

7. The apparatus of claim 6 wherein a masking region of the target temperature distribution is masked in a corresponding image region as the masking region of the measured temperature distribution, such that the heater is to heat a portion of the build material corresponding to a non-masked region of the measured temperature distribution.

8. The apparatus of claim 1 wherein the target temperature distribution is a substantially uniform temperature distribution.

9. The apparatus claim 1 wherein the target temperature distribution is a non-uniform temperature distribution.

10. A method comprising:
measuring a temperature distribution emitted by build material delivered to a support member;
masking or correcting the measured temperature distribution based on emissivity data of the build material;
heating, by a plurality of heating units, the build material to a target temperature distribution based on the corrected or masked measured temperature distribution; and
applying energy to the build material to cause a portion of the build material to coalesce and solidify.

11. The method of claim 10 further comprising selectively delivering coalescing agent to the portion of the build material to cause the portion to coalesce when the energy is applied.

12. A non-transitory computer readable storage medium including executable instructions that, when executed by a processor, cause the processor to:
cause a layer of build material to be delivered;
receive a measured temperature distribution of build material delivered to a support member;
mask a masking region of or correct the measured temperature distribution based on differences in emissivities in regions of the build material;
cause the build material to be heated to a target temperature distribution from the corrected measured temperature distribution.

13. The non-transitory computer readable storage medium of claim 8 further comprising executable instructions that, when executed by a processor, cause the processor to interpolate the measured temperature distribution before heating the build material.

14. The non-transitory computer readable storage medium of claim 8 further comprising executable instructions that, when executed by a processor, cause the processor to generate a compensation signal for a heating unit to heat a region of the build material to the target temperature distribution, the compensation signal generated based on one or more of a thermal process model or a look-up table.

15. The non-transitory computer readable storage medium of claim 8 further comprising executable instructions that, when executed by a processor, cause the processor to generate a compensation signal for a heating unit to heat a region of the build material to the target temperature distribution,
the compensation signal determined based on a ray tracing model having input parameters including the compensation signal and known physical factors of the apparatus, the ray tracing model outputting a model temperature distribution, wherein the compensation signal is determined by minimizing a difference between the target temperature distribution and the model temperature distribution.
